(19) United States
(12) Patent Application Publication
(10) Pub. No.: US 2005/0008992 A1
(43) Pub. Date: Jan. 13, 2005

(54) Apparatus for training on a bicycle connected to the apparatus

(76) Inventors: Johnny Westergaard, Stenlose (DK); Ebbe Finding, Gentofte (DK); Flemming Bruhn, Vedbaek (DK); Henrik Thor Christensen, Lyngby (DK)

Correspondence Address: BIRCH STEWART KOLASCH & BIRCH, PO BOX 747, FALLS CHURCH, VA, 22040-0747, US

(21) Appl. No.: 10/497,154

(22) PCT Filed: Nov. 29, 2002
(86) PCT No.: PCT/DK02/00803

Related U.S. Application Data
(60) Provisional application No. 60/334,110, filed on Nov. 30, 2001.

(30) Foreign Application Priority Data
Nov. 30, 2001 (DK) PA 2001 01785

(51) Int. Cl. G09B 9/04; G09B 19/16

(52) U.S. Cl. 434/61

(57) ABSTRACT

An apparatus for training on a bicycle connected to the apparatus, so that the bicycle is tiltable in a direction transversely to a plane defined by a frame of the bicycle. The bicycle is elevated to when the bicycle frame is tilted whereby the bicycle frame, by gravity, is biased towards the non-tilted position. A bicycle computer being adapted to collect and/or display course information while the bicycle is not connected to a training device and being adapted to control resistance providing means when the bicycle is connected to the training device. A wheel for training on a bicycle comprising resistance providing means comprising secondary drive means adapted to engage with the force transferring connector of the bicycle so as to apply resistance to rotation from the resistance providing means to the primary drive means of the bicycle.

### FIELD OF THE INVENTION

The present invention relates to an apparatus or an exercise device or bike trainer and more specifically to a bike trainer wherein the exercise takes place on a regular bike, e.g. a race bike, said bike being connected to the bike trainer.

### BACKGROUND OF THE INVENTION

Generally, devices for cycling or training on a bicycle or emulating training on a bicycle exist. The devices can generally be divided into two groups, a first group comprising devices where a bike capable of transporting a user from a point A to a point B is attached to a special training device and a second group of training devices which can not transport a user from a point A to a point B. The latter type is typically used in fitness centres for e.g. spinning but can also be used in private homes.

The known devices are typically adapted to allow the user to train in an awkward position as the bicycle instead of being tiltable is fixed in a certain position and thus leaves the user no impression of a real tour. Thus when the user of the bike rides the bike standing and using the total body weight to turn the pedals the bicycle does not tilt from side to side. Instead the bicycle is fixed and as a result the force applied to the bicycle may damage parts of the bicycle such as the frame, the wheels, the bottom bracket axle etc. Especially when the bicycle used is an expensive bicycle comprising a fragile frame, damage is possible.

Almost all bike trainers, which may be attached to a bicycle, comprises a simple drive roll, which is normally pressed into frictional engagement with the tyre of the rear wheel and thus applies resistance against turning to said wheel. To the drive roll is coupled resistance generating means such as the Eddy Current brake system, which is the most common used system.

In the Eddy Current brake system the resistance against rotation is typically altered by changing the position of one or more permanent magnets. The permanent magnets are typically connected to a handle via a cable, said handle being adapted to be attached to the handle bar of the bicycle. In some embodiments of the Eddy Current brake systems the magnets for creating resistance against rotation is provided by using both permanent magnets and electromagnets, the resistance of said electromagnets being adjustable by changing the electrical resistance to which it is coupled.

In the Eddy Current brake system the efficiency of the system depends on the force applied from the drive roll to the tyre and the characteristics of the surface of the drive roll and the surface of the tyre. During acceleration, the tyre may slip against the drive roll if the force applied from the drive roll to the tyre is too low. If in the other hand the force applied from the drive roll to the tyre is too high, the increased friction of the engagement may imply undesired heat and damage the tyre over a short period of time.

Another feature of the drive roll system is the noise generated. The performance of the Eddy Current Brake system increases with a high rotational speed of the axle of the system. Thus the radius of the drive roll is often designed to be as little as possible so as to ensure the highest gear ratio as possible. The noise generated increases with the speed of the drive roll.

The tolerances of the permanent magnets in the Eddy Current brake system are relatively rough. Furthermore the size of the magnetic field decreases with rising temperature resulting in changes in the resistance generated during operation of the system.

A feature of the Eddy Current brake is that the resistance generated at low speeds is low while the resistance generated at high speeds is high. The system is therefor not able to emulate up-hill cycling where the speed is low and the resistance is high.

The majority of bike trainer systems include means for controlling the resistance, said means being attachable to the handle bar of the bicycle. The control means are designed specifically to the training device. When the user desires to cycle on the real road he must detach the control means and re-attach a bicycle computer designed to collect and display e.g. speed, rotations per minute etc. If the user afterwards desires train on the cycle trainer again he needs to detach the bicycle computer and re-attach the control means.

Some training systems comprises means for presenting a video and audio while the user is using the training device. The images presented may be a pre-recorded film which has been recorded using equipment which due to its size must be mounted to a car. Thus the system does not provide the user with means for recording the actual route of the bicycle as the route recorded will be the route covered by the car. Furthermore the cyclist always needs to be followed by a car and can therefor not bike alone. Finally the cyclist can not record a mountain bike route in a dense forest as it may not be possible for the car to follow.

### DESCRIPTION OF THE INVENTION

It is an object of the present invention to provide a training device which overcomes the above mentioned disadvantages. Accordingly, the present invention relates to an apparatus for training on a bicycle connected to the apparatus, so that the bicycle is tiltable in a direction transversely to the plane defined by a frame of the bicycle, between opposite positions, said apparatus comprising:
a base member,
fastening means to be releasably fastened to the frame of the bicycle and
a mechanism interconnecting the base member and the fastening means, said mechanism being adapted to elevate the fastening means and the bicycle frame connected thereto when the bicycle frame is tilted from an intermediate position towards any of said opposite positions whereby the bicycle frame is biased towards the intermediate position by gravity.

The bicycle may be an ordinary bike for everyday use but could also be a racing bike for either road racing or racing on a closed course. Furthermore the bike could be a mountain bike (MTB) or a trial bike or a one wheel bike or a tandem bike or a bike with more than two wheels such as a bike with three wheels or a bike with four wheels.

The bicycle may be tiltable in a direction transverse to a plane defined by the bicycle frame, but could also be tiltable in a direction transverse to a direction defined by the gravital force, such as transverse to the direction in which the bicycle would drive if it was not connected to the apparatus. Furthermore the bicycle may be tiltable in a direction transverse to a plane defined by the gravital force and a direction transverse to the axle of the front wheel and/or the rear wheel.

The transverse tilting direction may define an angle in relation to the aforementioned planes (e.g. defined by the bicycle frame) and/or directions. The angle may be between 45 degrees and 90 degrees, such as between 50 degrees and 90 degrees, such as between 55 degrees and 90 degrees, such as between 60 degrees and 90 degrees, such as between 65 degrees and 90 degrees, such as between 70 degrees and 90 degrees, such as between 75 degrees and 90 degrees, such as between 80 degrees and 90 degrees, such as between 85 degrees and 90 degrees, such as 90 degrees.

The apparatus may comprise a base member for supporting the apparatus. Said base member may be made of a plate of metal or plastic or a composite or a combination hereof. The shape of the plate may be elliptic or round or a quadrangle such as a square or a rectangle or a triangle or an arc segment, or parts or combinations here of. Alternatively the base member may comprise a plurality of rods attached to each other forming a shape such as an H-structure or another shape. The base member may be adapted to stand on a floor or to be attached to a floor and/or a wall and/or a ceiling.

The apparatus may comprise means for adjusting the height of bicycle, such as means for adjusting the height of the rear wheel and/or the height of the front wheel or the height of the entire bicycle.

Furthermore the apparatus may comprise a fastening means to be releasably fastened to the frame of the bicycle, such as to be releasably fastened to the chain stay and/or the seat stay and/or the crossbar and/or the down tube and/or the head tube and/or the seat tube and/or the bottom bracket axle and or the fork and/or the seat post. Alternatively the fastening means may be releasably fastened to the front and/or rear hub or between the frame and one or more of said hubs. The fastening means may comprise a snap-lock or other means for releasably fastening the bicycle to the apparatus.

A mechanism may interconnect the base member and the fastening means, said mechanism may be adapted to elevate the fastening means and the bicycle frame connected thereto when the bicycle frame is tilted from an intermediate position towards any of said opposite positions whereby the bicycle frame is biased towards the intermediate position by gravity. When the bicycle is tilted a part of the bicycle may not be elevated e.g. the front wheel may remain in the base position such as being positioned on a floor while the rest of the bicycle is elevated.

The mechanism may comprise a connecting member and a linkage connected to the base member. A first end of the connecting member may be pivotally and/or spherically connected to the linkage and a second end may be connected to the fastening means. The connecting member may be mounted so as to follow the tilting movement of the bicycle, e.g. so that the tilting angle of the connecting member is substantially equal to the tilting angle of the frame of the bicycle. Said tilting angles may also be different from each other when the bicycle is tilted.

The linkage may be adapted so as to move the connecting member upwards and/or in a direction opposite the direction of the gravital force acting on the bicycle when the bicycle is tilted towards the opposite positions. Furthermore the linkage may move sidewards when the frame of the bicycle is tilted. The linkage may move to the same side as the side to which at least a part of the frame is titled but may also move to the opposite side. A first part of the bicycle may move to one side when the bicycle is tilted while a second part is moved to another side.

The apparatus may further comprise a guide member which may be fixedly connected to the base member and defining retaining means which may be adapted for tiltably and slidingly retaining of the connecting member.

The retaining means may form an opening for receiving a pin. Said opening may be a plain bearing but could also be a rod formed as a loop e.g. comprising means for reducing the frictional resistance between the inner walls of the loop and the pin. The pin may be attached to the base member but could also be attached to the connecting member. The opening may be attached to the base member but could also be attached to the connecting member.

Alternatively the retaining means may form a groove for receiving a ball joint. Said groove may be provided in a rod but could also be provided by folding a flat piece of metal or plastic or a composite or a combination hereof. The ball joint may be provided by a screw or by chip cutting a piece of metal or plastic or composite or a combination hereof. The groove may be comprised in the base member and/or in the connecting member. The ball joint may be comprised in the base member and/or in the connecting member.

The linkage may comprise at least one primary linkage member and at least one secondary linkage member. The connecting member may be pivotally and/or spherically connected to the at least one primary linkage member, e.g. by use of a bearing or a screw or use of nuts and bolts. The at least one secondary linkage member may be pivotally and/or spherically connected to the primary linkage member at a first end and at a second end it may be connected to the base member.

The linkage may in one embodiment comprise one primary linkage member and a first and a second secondary linkage member. The connecting member may be pivotally and/or spherically connected to a point on the primary linkage member, said point being positioned between a first end and a second end of the primary linkage member, e.g. the distance from the point to the first end may be substantially equal to the distance from the point to the second end. A first end of the first secondary linkage member may be pivotally and/or spherically connected to the first end of the primary linkage member and a second end of the first secondary linkage member may be pivotally and/or spherically connected to the base member. Furthermore a first end of the second secondary linkage member may be pivotally and/or spherically connected to the second end of the primary linkage member and a second end of the second secondary linkage member may be pivotally and/or spherically connected to the base member.

When the apparatus is tilted to a first side the pivotal connection between the primary linkage member and the first secondary linkage member may move downwards and/or to the first side. At the same time the pivotal connection between the primary linkage and the second secondary linkage member may move upwards and to the first side. This may result in a upwards and/or sidewards movement of the pivotal and/or spherical connection between the first linkage member and the connecting member, said sidewards movement may be to the first side.

The opposite positions may comprise a first and a second position. The first and second positions being placed on each side of the plane defined by the bicycle frame. The first position may be located at the first side and the second position may be located at the second side. When the bicycle is tilted to the first and/or when the bicycle is tilted to the second position the bicycle may be tilted with an angle in relation to the gravital force of 45 degrees, such as 40 degrees, such as 35 degrees, such as 30 degrees, such as 25 degrees, such as 20 degrees, such as 15 degrees, such as 12.5 degrees, such as 10 degrees, such as 9 degrees, such as 8 degrees, such as 7 degrees, such as 6 degrees, such as 5 degrees, such as 4 degrees, such as 3 degrees, such as 2 degrees, such as 1 degree. In an embodiment of the invention the tiltability of the frame of the bicycle may be asymmetric, e.g. so that the bicycle may be possible to tilt to the first side with an angel of 35 degrees and to the second side with an angle of 20 degrees. The asymmetry may be arranged with other combinations of angles e.g. combinations of the angles mentioned above. The tiltability may also be symmetric.

The base member may be comprise supporting members arranged over a square of a size of 5 square meters, such as 4 square meters, such as 3 square meters, such as 2.5 square meters, such as 2 square meters, such as 1.5 square meters, such as 1 square meters, such as 0.5 square meters. Furthermore the base member may comprise adjustable pinions.

The apparatus may be made of a material from a group consisting of: wood, plastic, glass fibre, a composite material, rubber, a metal or an alloy such as iron, steel, aluminium, magnesium, titanium, copper, nickel, zinc or a combination hereof. One part of the apparatus may be made of one material while another part may be made of another, e.g. the base member may be made of wood while the mechanism is made of steel.

In an embodiment the apparatus may further comprise resistance providing means, the resistance being applied to the user of the apparatus. The resistance providing means may be a wheel, which when turned has a large air resistance, e.g. arranged so that the air is moved towards the user of the apparatus so as to cool down the driver or to simulate headwind. The resistance providing means may also be means for creating frictional resistance between a wheel and a brake, the brake may be adjustable. The brake may also be a wire turned around a wheel, so that the tension of the wire determines the frictional resistance and thereby the resistance provided to the user of the bicycle.

The resistance providing means may be operable by the user of the bicycle, e.g. so that the user of the bicycle can change the resistance during training. The resistance may also be changeable before and/or after the training.

In another embodiment the resistance providing means may be adapted to operate with a frame e.g. the frame of the bicycle, the frame may comprise a primary drive means for transferring force from the user to a secondary drive means via a force transferring connector. The primary drive means may be a chain wheel connected to the pedals. The force transferring connector may be a chain, but could also be a belt drive. Alternatively the transferring connector may be a cardan shaft or a plurality of toothed wheels.

The apparatus may be adapted so that the resistance providing means comprises a generator having a axle adapted for rotation around a centre axis, said axle may be directly connected to the secondary drive means, but could also be connected via a plurality of toothed wheels and/or chains and/or belt drives.

The secondary drive means may comprise at least one disc having at least one peripheral surface with a radial distance to the centre axis of the axle. The force transferring connector may be adapted to engage the peripheral surface so as to transfer movement of the force transferring connector to the peripheral surface of the disc for rotating the axle. In a preferred embodiment the at least one disc may be a toothed wheel e.g. a free wheel and the force transferring connector may be a chain.

In a preferred embodiment the resistance providing means may be comprised in a housing, releasably connected to the bicycle. The housing may be shaped as a triangle or a quadrangle or a circle or an ellipse or anther shape. The housing may be shaped as a wheel having substantially the same dimensions as an ordinary bike wheel. The wheel may be adapted to turn when the generator is used but the wheel may also be adapted to stand substantially still when the generator is used. The generator may be placed substantially in the middle of the wheel so that the axle of the generator forms a hub to which a free wheel is attached. Furthermore the housing may comprise means for determining the use of one or more brakes attached to the bicycle. Said detecting means may be adapted to detect the movement of the brakes e.g. over a continues scale so as to determine the pressure applied from the brakes. In an embodiment the means for determining the use of the one or more brakes may be attached to or comprised in the brake handles so as to determine the use of the brakes, but said means may also be attached to or comprised in the frame of the bicycle so as to determine the use of the brakes e.g. at a position close to the brakes. Alternatively said means may be attached to or comprised in force transferring means, said force transferring means being adapted to transfer a force applied from the brake handles to the brakes. The apparatus may alternatively comprise a virtual brake. The virtual brake may comprise means for determining a force applied from the user to e.g. a handle, said means may be attachable to e.g. the handle bars of the bicycle. When the virtual brake is activated the control means may change the resistance of the generator.

The generator may be an electrical generator. The generator may be used as a motor but could also be used as a means for generating an electrical power, or could also be used as means for generating resistance applied to the driver e.g. via the chain of the bicycle. The electrical generator may generate a maximum torque when the revolutions per minutes is substantially zero, but could also generate the maximum torque at a rate of rotation being between 0% and 5% of the maximum rate of rotation, or between 0% and 10% or between 0% and 20%, or between 0% and 30%, or between 0% and 40%, or between 0% and 50%, or between 0% and 60%, or between 0% and 70%.

The electrical generator may supply an effect being at least 70% of a maximum effect at a rate of rotation being at least 10% of a maximum rate of rotation, such as an effect being at least 60% of the maximum effect, such as an effect being at least 50% of the maximum effect, such as an effect being at least 40% of the maximum effect, such as an effect being at least 30% of the maximum effect, an effect being at least 20% of the maximum effect.

The electrical generator may supply a maximum effect at a rate of rotation being 50% of the maximum rate of rotation, such as at a rate of rotation being 40% of the maximum rate of rotation, such as at a rate of rotation being 35% of the maximum rate of rotation, such as at a rate of rotation being 30% of the maximum rate of rotation, such as at a rate of rotation being 25% of the maximum rate of rotation, such as at a rate of rotation being 20% of the maximum rate of rotation, such as at a rate of rotation being 15% of the maximum rate of rotation, such as at a rate of rotation being 10% of the maximum rate of rotation.

The generator may require little or no maintenance during the life time of the apparatus, such as for a period of 1 year, such as for a period of 2 years, such as for a period of 3 years, such as for a period of 4 years, such as for a period of 5 years, such as for a period of 6 years, such as for a period of 7 years, such as for a period of 8 years, such as for a period of 9 years, such as for a period of 10 years, such as for a period of 12 years, such as for a period of 14 years, such as for a period of 16 years, such as for a period of 18 years, such as for a period of 20 years.

The generator may be an electrical generator to which a predefined resistance is connected, by means of electrical conductors. In another embodiment the resistance may be adjustable, e.g. so that a plurality of predefined resistances may be connected to the generator. Alternatively the adjustable resistance may be adjustable over a continuos scale, e.g. by use of a potentiometer.

The generator may be able to generate an effect being substantially identical from time to time, e.g. the generator may at a time t1 be controlled by the control means so as to deliver an effect or a resistance against turning being 350 watts and at a time t2 the control means can control the generator so as to deliver substantially the same effect or resistance against turning. The difference between the effect delivered at time t1 and at time t2 may be 10%, such as 9% such as 8%, such as 7% such as 6%, such as 5%, such as 4%, such as 3% such as 2%, such as 1%.

The electrical generator may be connected to control means adapted to adjust the resistance of said generator. Said control means may be adapted to be releasably attached to a handlebar of the bicycle.

In an embodiment the control means may comprise a first computer system which may comprise an operating system. The computer system may comprise input means for collecting data in a first format and/or processing means for processing the data and/or output means for presenting data in a second format and/or data storage means which may have stored therein a computer program. The computer program may be adapted to operate with an operating system but may also be adapted to operate without an operating system. The control means may comprise means for changing the resistance.

The control means may be adapted to vary the resistance over time, e.g. so that the resistance is increased while training but the resistance may also be decreased during the training. The resistance may also be increased and decreased in various patterns during training so as to enable cardiovascular training. In another embodiment the control means may be adapted to vary the resistance in response to the number of revolutions per minute of the secondary drive means and/or of the primary drive means. The resistance may also be changed in response to the total number of revolutions made during the exercise, so as to simulate a virtual training course. The control means may be adapted to vary the resistance in response to a heart rate or a EKG of the user, e.g. so as to allow the user to perform cardiovascular training, where the heart rate or a EKG must be between certain limits. Said limits may change during the training. In another embodiment the control means may change in response to a blood pressure of the user, e.g. so that users with a heart illness or a weak heart can be warned if the blood pressure is reaching a undesired limit. The control means may be adapted to vary the resistance in response to an oxidation of the blood of the user, e.g. so that the apparatus can be used to retrieve information about the absorption of oxygen during training or to enable the user to be warned if the absorption of oxygen is critically low or high. Furthermore the resistance may be changed in response to the heart rate or a EKG of the user and/or the blood pressure of the user and/or the oxidation of the blood of the user and/or the time and/or the number of revolutions per minute of the secondary drive means and/or of the primary drive means. In the latter embodiment the resistance may be changed so as to simulate a training course, e.g. training in a hilly terrain.

The control means may be adapted to vary the resistance in response to a weight of the user. The weight of the user may be interred in the control means via the input means. The weight may be interred in the control means prior to using the apparatus, but could also be interred into the control means while the apparatus is used, or could also be interred into the control means subsequent to using the apparatus.

The control means may be adapted to vary the resistance in a predefined pattern, e.g. a pattern where the resistance changes in desired intervals so as to enable interval training i.e. cardiovascular training. Alternatively the control means may be adapted to vary the resistance in a predefined pattern and in relation to the time and/or number of revolutions per minute of the secondary drive means and/or of the primary drive means. In the latter case the resistance may be changed so as to simulate e.g. a hilly terrain in which the user of the apparatus is performing interval training.

Furthermore the control means may be adapted to vary the resistance in a user defined pattern, thus enabling the user of the system to define a pattern which has a similar training impact as a specific route which the user normally trains on when riding the bicycle on the road or in hilly terrain.

In an embodiment the control means may be adapted to vary the resistance in response to a virtual course. The virtual course may be predefined by the user e.g. by use of a computer connected to the control means. The user defined virtual course may be a course which the user has defined so as to simulate a course which the user trains on when riding the bicycle on the road. Alternatively the course may be predefined and stored in the control means when the apparatus is produced but the predefined course may also be purchased separately and then installed into the control means e.g. by use of a hard disc or a floppy disc or a CD-ROM or a DVD or a DVD-R/W or a DVD+R/W or a DVD-ROM or a flash memory or an EPROM or an EEPROM or a memory card or via the internet or by use of another storage media.

The control means may be adapted to vary the resistance in response to a real course, said course being pre-recorded and stored in the data storage means. The course may be pre-recorded by the user but may also be pre-recorded by others e.g. the manufacturer of the apparatus. The user may pre-record the real course by cycling on a bicycle having the control means attached thereto. The pre-recorded course may be installed in the data storage means when the apparatus is produced but may also be stored afterwards, e.g. when the user of the bike purchased a new training program and installs it in the control means. The real course may also be transmitted real-time to the apparatus e.g. via the internet and/or a local network so as to allow the user to compete with others. Furthermore the real-time transmitted course may be a course which professional cyclists are competing on at the same time, whereby the user of the apparatus can compete with the riders of e.g. the Tour de France.

The control means may be adapted to vary the resistance so as to emulate a virtual gear, e.g. when a bicycle with only e.g. one gear is attached to the apparatus the control means may be configured so that the user will experience the feeling of riding on a bicycle with a 5 speed gear or a 6 speed gear or a 10 speed gear or a 12 speed gear or a 15 speed gear or an 18 speed gear or another number of gears.

The control means may be adapted to collect and/or display course information while the bicycle is not attached to the apparatus. In an embodiment the control means is comprised in a normal bicycle computer so that the user needs only to attach one computer to e.g. the handle bar of the bicycle. The bicycle computer may be adapted to be releasable connected to the bicycle. Said bicycle computer may be used when the bicycle is used together with the apparatus but may also be used when the bicycle is used on the road or in a forest or at another outdoor place. In the latter situation the control means may collect course information such as speed and/or position of the bicycle and/or resistance to rolling between the bicycle and a floor e.g. a road on which the bicycle is placed and/or the altitude of the bicycle and/or the angle between a plane defined by the floor and the gravital force and/or the speed of the wind and/or the direction of the wind and/or the heart rate or a EKG of the user and/or the blood pressure of the user and/or the oxidation of the blood of the user and/or revolutions per minute of the secondary drive means and/or the primary drive means. The position of the bicycle may be collected in a resolution of three variables e.g. x, y, z but may also be collected in relation to longitude and latitude.

The control means may be adapted to collect and/or display at least a part of the course information. E.g. the user may in some cases choose only to collect and display speed and revolutions pr. minute while the user in other cases may choose to collect all the above described course information while only speed is displayed or all information is displayed. The user may choose to collect and/or display any combination of the above mentioned information or other information.

The apparatus may comprise means for collecting and/or presenting audio and/or video. The apparatus may comprise loudspeakers and/or a camera and/or a microphone and/or a screen for playback of images. The images displayed on the screen may be virtual images but could also be real images. The screen may be attached to the bicycle but may also be hung on the wall or stand alone. The sound played on the loudspeakers and/or recorded by the microphone may be music e.g. by use of a music decoder or virtual and/or real ambience e.g. sound of other bikes and people in the street.

The processing means may be adapted to display images and/or play sounds and the storing means may be adapted to store images and/or sounds. The pictures may be still pictures and/or moving images. The storing means may be VHS or DVD or DVD-R/W or DVD+R/W or DVD-ROM or CD-ROM or magnetic tape or a hard disc or a floppy disc or an EPROM or an EEPROM or a flash memory or a memory card.

The processing means may be adapted to display a virtual route on the screen but could also be adapted to playback a real course.

The invention according to the first aspect of the invention may comprise any feature or element of the second and/or third aspect of the invention.

A second aspect of the invention relates to a bicycle computer for training with or without an attachable training device, the bicycle computer comprising
a computer system comprising input means for collecting data in a first format, processing means for processing the data, output means for presenting data in a second format, and data storage means having stored therein a computer program,
the computer system being adapted to collect and/or display course information while the bicycle is not connected to the training device and
the computer system being adapted to control resistance providing means comprised in the training device

In an embodiment of the invention the bicycle computer can be used for training out door e.g. from point A to point B. According to the same embodiment the same bicycle computer may be used for training on a training device for training on a bicycle e.g. the apparatus describes in the preceding. The advantage is that the user need not to attach special equipment to the bicycle while training with the training device and that the computer may collect course information which can afterwards be used to simulate the same conditions on the training device as were experienced when driving outdoor.

The computer may be adapted to, during a training session, display course information from the present session and from at least one reference session. The reference session may be a session recorded on the same computer or on another computer. E.g. the reference session may be recorded by another bicyclist and thus it may be possible for a person to perform a virtual race against the other person using the training device or when riding on the road following the same route as the other person did.

The reference session may be a previous session recorded on the same computer e.g. by the same person and thus making it possible for one person to compete against oneself i.e. oneself on a previous training course. The reference session may be calculated by the computer in accordance with predetermined standard data. The predetermined data may be the information about a target training state or information about another person. Thus it may be possible for a first person in a current training state to compete against said first person in the target training state. The standard data may comprise weight, cardiovascular state and age of the person which is competed against.

The invention according to the second aspect of the invention may comprise any feature or element of the first and/or third aspect of the invention.

A third aspect of the invention relates to a wheel for training on a bicycle comprising a primary drive means and a force transferring connector, said wheel comprising
means for realisably connecting the wheel to the bicycle
resistance providing means comprising secondary drive means adapted to engage with the force transferring connector so as to apply resistance to rotation from the resistance providing means to the primary drive means.

The wheel may comprise a force transferring connector so that the wheel can be used on a bicycle comprising only a primary drive means. Alternatively the force transferring connector may be supplied to a bicycle comprising only a primary drive means and a wheel comprising only a secondary drive means.

The wheel may be a replacement for a bicycle wheel. The replacement wheel may be adapted to roll on a surface e.g. a road. In an embodiment the replacement wheel may not be able to roll on a surface and may then not be adapted to move the bicycle e.g. from a point A to a point B. The replacement wheel may be a compact unit replacing an ordinary wheel, having any shape e.g. round, triangular, quadrangular or any other shape.

The invention according to the third aspect of the invention may comprise any feature or element of the first and/or second aspect of the invention.

### DETAILED DESCRIPTION OF THE INVENTION

An embodiment of the invention will now be described in details with reference to the drawing in which:

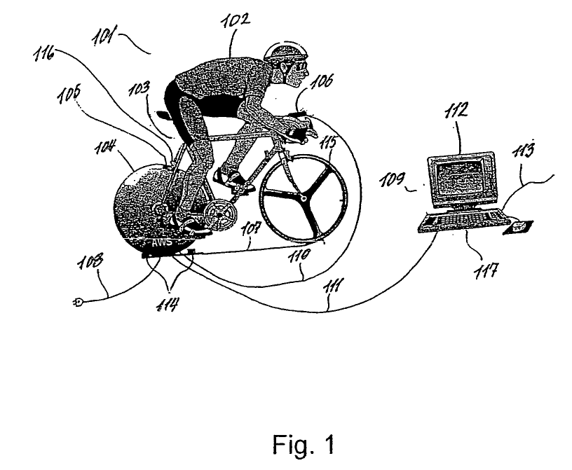

FIG. 1 shows a cyclist using the invention according to the first aspect,

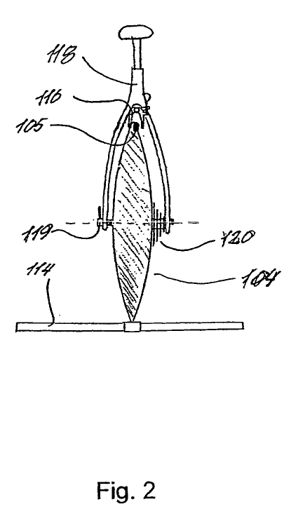

FIGS. 2, 3, 5a and 5b show an invention according to the first aspect of the invention,

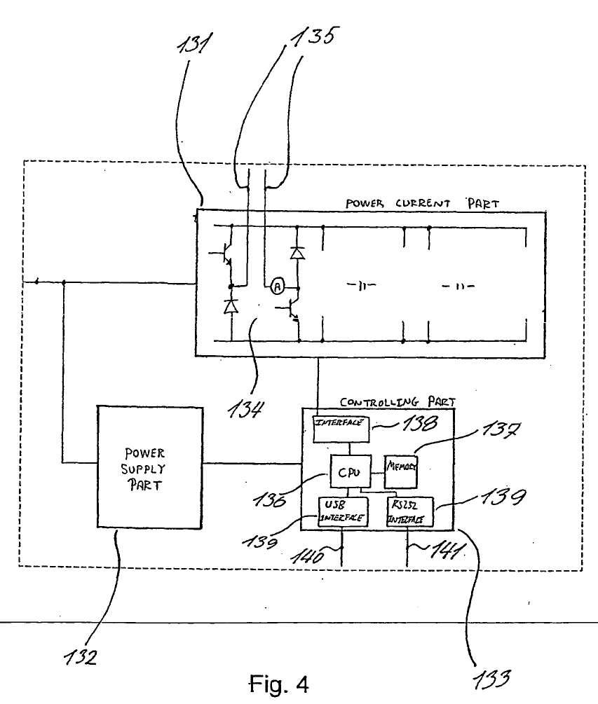

FIG. 4 shows controlling means according to the first aspect of the invention,

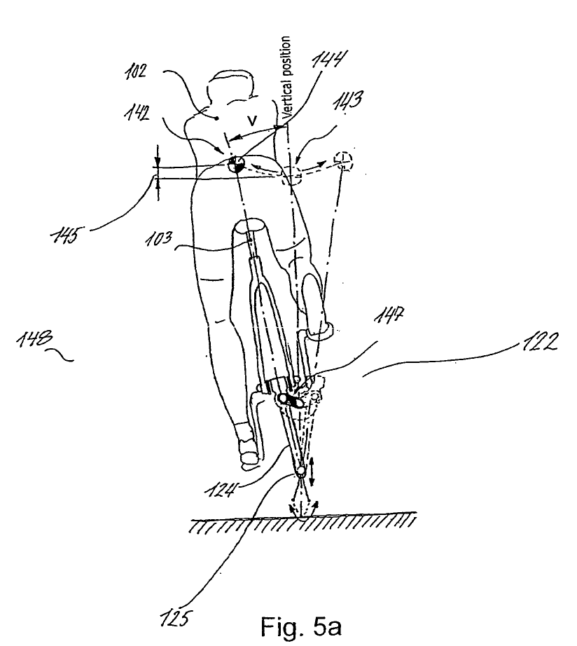

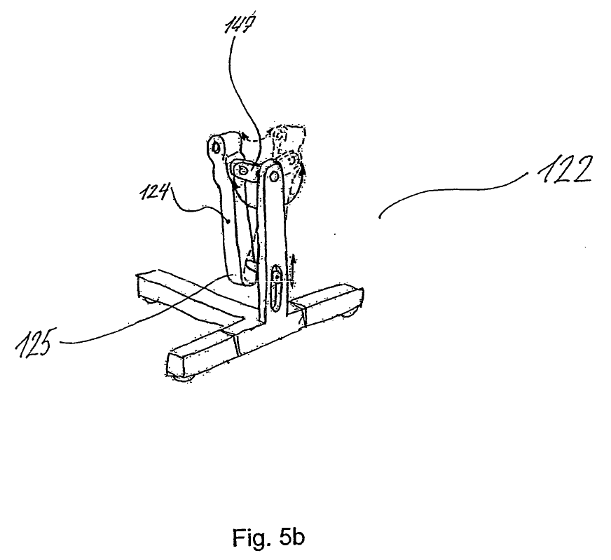

FIGS. 5a/5b show an invention according to the first aspect of the invention,

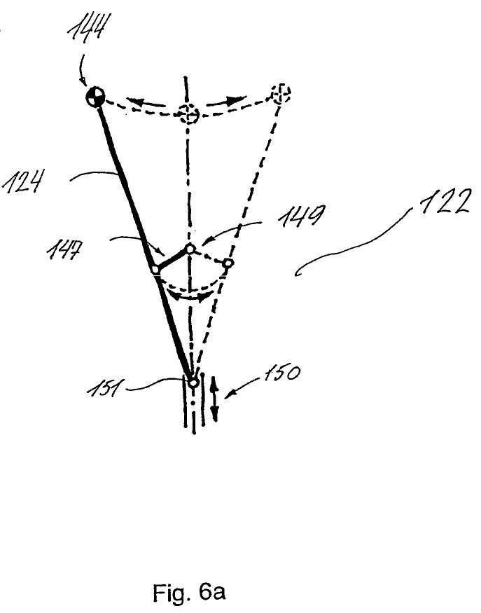

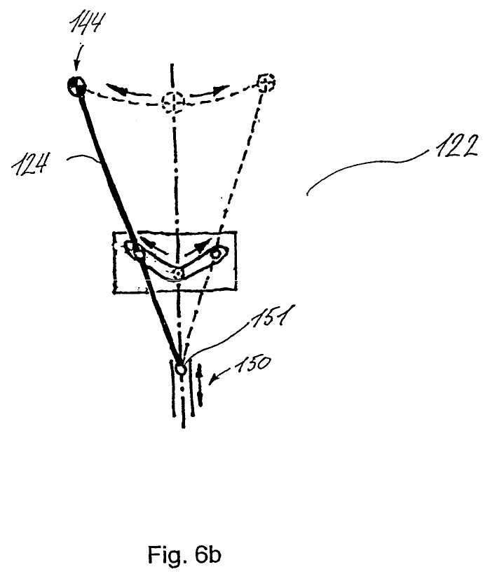

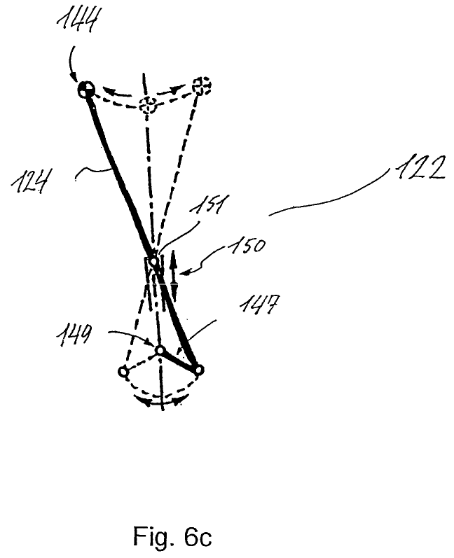

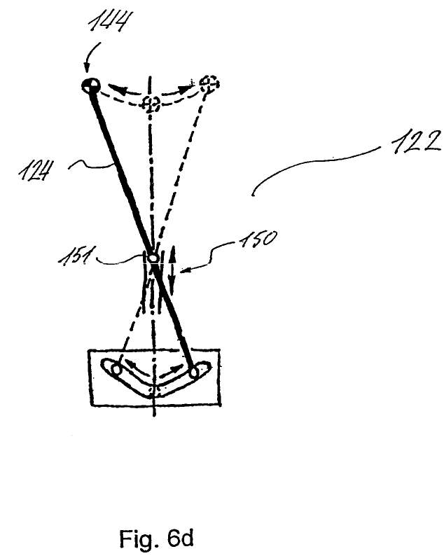

FIGS. 6a, 6b, 6c, 6d, 7, 8a and 8b show a tilting principle according to the first aspect of the invention,

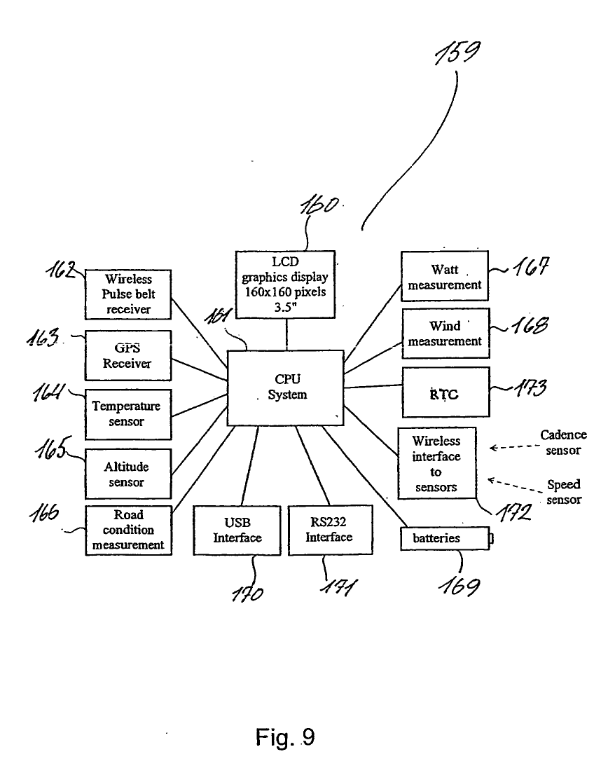

FIG. 9 shows an invention according to the first and second aspect of the invention,

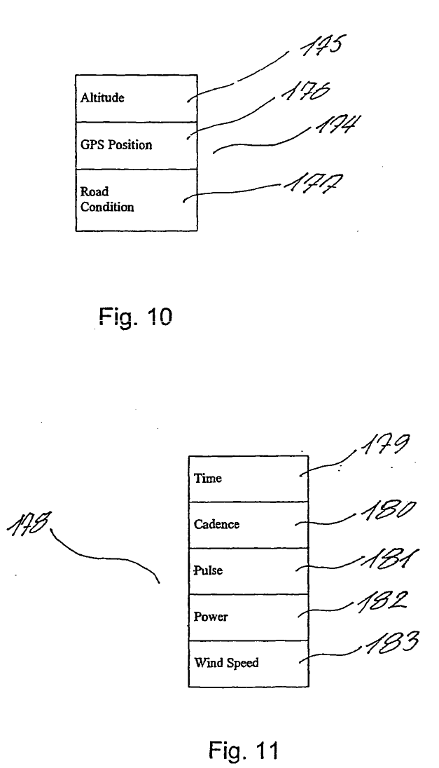

FIG. 10 shows the format of the route record and playback data and

FIG. 11 shows the format of the performance record and playback data

### BEST MODE OF CARRYING OUT THE INVENTION

FIG. 1 shows a cyclist 102 cycling on a cycle 103 attached to an training device 101 comprising a wheel 104 which is mounted on the cycle 103, replacing a rear wheel for outdoor use. To the wheel 4 is realisably attached two easy click on and click off feet 114. A holder 107 substantially prevents the front wheel 115 from turning from side to side. The wheel 104 comprises a brake sensor 105 which detects movement of the brake 116 of the bike 104. The training device 101 is connected to a power supply via a power cable 108. The display 106 is attached to the handlebar. The wheel 104 and the display 106 are inter connected via a first cable 110. The first cable 110 may be a standard RJ45 cable comprising a RS232 interface. A second cable 111 e.g. a USB cable interconnects the wheel 104 and a computer 109 comprising a screen 112 and a keyboard 117 and a network connection 113 e.g. an internet connection

FIG. 2 shows a rear view of the wheel 104 realisably attached to a frame 118. The wheel 104 is realisably attached to the frame 118 by means of a fast lock system 119 similar to the fast lock systems comprised in a normal bicycle-racing wheel. The wheel comprises a common free wheel 120, e.g. Shimano or Campagnolo. The wheel comprises a brake sensor 105 which may detect movement of the brake 116. To the wheel 4 is realisably attached two easy click on and click off feet 114.

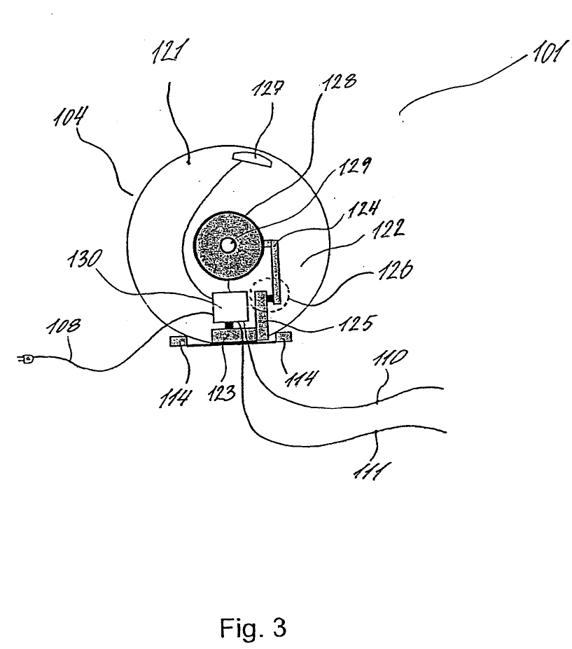

FIG. 3 shows the wheel 104, comprising two covers 121, which serves as shields as well as the outer look of the wheel 104. The training device 101 comprises two easy click on and click off feet 114, realisably attached to the wheel 104. The training device 101 comprises a tilting mechanism 122, comprising a base member 123, a connecting member 124 and a linkage 125 pivotally and/or spherically connected at a point 126 to the connecting member 124. The training device 101 further comprises brake detecting means 127 and a resistance providing means 128 e.g. a Switched Reluctance Machine providing resistance to the force transferring connector e.g. a chain engaging with a gear wheels 129. A controller PCB 130 is mounted inside the wheel 104. To the controller PCB 130 is connected a power cable 108, a first cable 110 e.g. comprising a RS232 interface for connection to a display 106 and a second cable 111 e.g. a USB cable, which interconnects the wheel 104 and a computer 109.

FIG. 4 shows the principle of the controller PCB 130, comprising a power current part 131, a power supply part 132 and a controlling part 133. The power current part 131 comprises all the high voltage and high power components needed to drive the Switched Reluctance Machine (SRM). The SRM-unit works as electrical generator as well as a motor. Unlike the Eddy Current brake; the SRM unit maintains full moment of inertia at few revolutions per second even at zero revolutions per second. It generates high power at low speed and thus eliminates the need for the high gearing ratios which is followed by noise. As the SRM unit works as motor as well as generator, it can simulate both up-hill and down hill and thus making cycling much more realistic.

In FIG. 4 is disclosed an H-bridge power stage 134 of one of the three phases. Said H-bridge power stage 134 is connected to the Switched Reluctance Machine via the conductors 135. The power supply part 132 transforms the main voltage to all low voltages needed. The controlling part 133 contains the controlling CPU 136, the memory 137, internal interfaces 138 to the power current part and the external interfaces 139 connected to a personal computer via the a first conductor 140 and connected to a display unit via a second conductor 141.

FIGS. 5a and 5b show the tilting mechanism 122. When the cyclist 102 uses the tilting mechanism 122 he may tilt to a first position 142, in which the cyclist 102 will be forced to an intermediate position 143 by a gravital force. At the intermediate position 143 the centre of gravity 144 of the cyclist 102 and the bicycle 103 and the tilting mechanism 122, is at its lowest position in relation to the direction of the gravital force. The vertical difference 145, illustrates the vertical difference of the centre of gravity 144 between the intermediate position 143 and the first position 142. When the cycle 103 is tilting towards the first position 142 the movement arm 147 moves to a first side 148, while a first end 125 of the connecting member 124 moves in an opposite direction of the direction of the gravital force.

FIGS. 6a, 6b, 6c and 6d show four different embodiments of the tilting mechanism 122 principle. The tilting mechanism 122 comprises a connecting member 124, a movement arm 147, a centre of gravity 144 of the cyclist 102 and the bicycle 103 and the tilting mechanism 122. FIGS. 6a and 6c discloses a fix-point 149, in which the mechanism may be fixed. FIGS. 6a, 6b, 6c and 6d show a guiding mechanism 150 which retains a retaining point 151 of the connecting member 124.

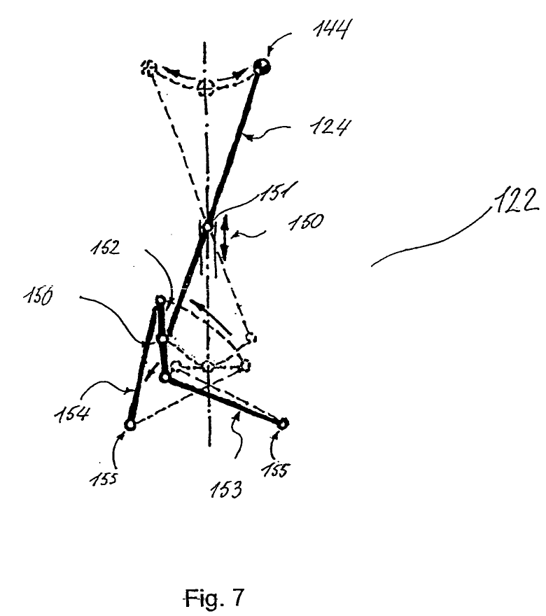

FIG. 7 shows an embodiment of the tilting mechanism 122, comprising a connecting member 124, a centre of gravity 144 of the cyclist 102 and the bicycle 103 and the tilting mechanism 122. The tilting mechanism further comprises a guiding mechanism 150 which retains a retaining point 151 of the connecting member 124. Furthermore the mechanism comprises a primary linkage member 152, a first secondary linkage member 153 and a second secondary linkage member 154. The first secondary linkage member 153 is e.g. pivotally connected a base member in a second end 155 and the second secondary linkage member 154 is e.g. pivotally connected a base member in a second end 155. The connecting member 124 is e.g. pivotally connected to the primary linkage member 152 at a point 156

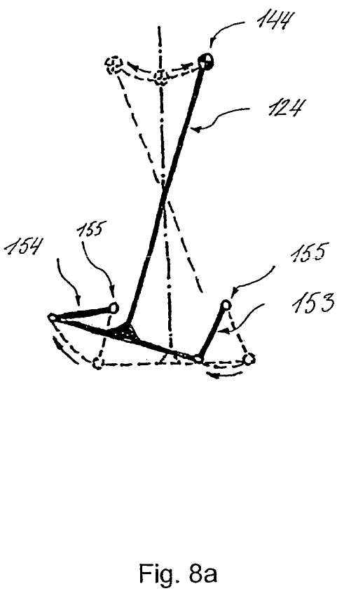

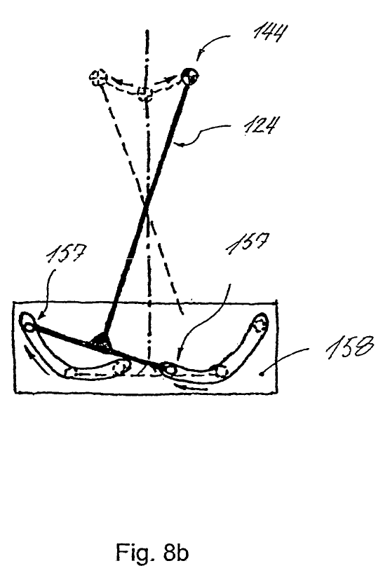

FIGS. 8a and 8b shows an embodiment of the invention, comprising a connecting member 124, a centre of gravity 144 of the cyclist 102 and the bicycle 103 and the tilting mechanism 122. The mechanism further comprises cam rollers 157, second linkage members 153, 154 which are e.g. pivotally connected a base member in a second end 155 and a plate with milled curve 158.

FIG. 9 shows an embodiment of the control means 159, comprising a display 160, a CPU System 161 e.g. with a high performance RISC microprocessor and a flash memory, which is able to store many hours of route and performance data. In the embodiment the control means 159 comprises a heart rate or a EKG belt receiver 162, a GPS receiver module 163, a temperature sensor 164, an altitude sensor 165, road determining means 166, watt measuring means 167, wind measuring means 168 and batteries 169. The control means 159 further comprises an USB interface 170, a RS232 interface 171 and wireless interface sensors 172. Finally the control means 159 comprises a real time clock 173.

The display 160 replaces a normal cycle computer. The display 160 can work as a normal cycle computer with all known features included. The characteristics recorded are the elevation, place, the GPS coordinates (if a GPS receiver module 163 is installed) and the character of the surface of the road (if the road determining means 166 is installed). The performance of the user can also be recorded, i.e. speed, cadence, watt performance and the force balance of left and right leg. The watt performance can either be calculated (weight, altitude, wind, speed) or an optional watt sensor i.e. watt measuring means 167 can be mounted.

The control means 159 can control the wheel 104, but it's not mandatory since a standard personal computer can control the wheel as well. The routes recorded (the characteristics) can be “replayed” on the wheel 104, and thus the user can ride the same route indoor as just recorded outdoor. The performance recorded can be used later as a reference during training indoor, and thus the user can compare and investigate the increase/decrease of the performance. The routes can freely be up and downloaded to a standard personal computer. Routes recorded by other users or routes from world famous places can be down loaded from a website.

FIG. 10 shows the route recording data format 174. The Altitude 175 is a mandatory parameter to measure and store. With the altitude 175 and position (ex. a fixed distance per altitude data) as the only parameters, the major characteristics can be replayed at a later time. The GPS position 176 is optional, can be used for visualising the route, and to put in wind directions. The Road condition 177 is also optional, can be used to measure the roughness of the surface. The layout of the route recording data format 174 is flexible. Future options/functions of the display can require an extension of the data format.

FIG. 11 shows the performance data format 178. The time 179 is a mandatory parameter to measure and store. With the time 179 and position (ex. a fixed distance per time data) as the only parameters, the major performance can be reviewed at a later time. The Cadence 180 is optional. The heart rate 181 in beats per minute is optional, but vital for evaluate the condition of the user at a later time. The power 182 is optional. If an external watt measurement unit is installed, the output from this unit can be stored. Otherwise, the watt can be calculated (roughly) from the other parameters stored. The wind speed 183 is optional. The layout of the route recording data format 174 is flexible. Future options/functions of the display can require an extension of the data format.

1. An apparatus for training on a bicycle connected to the apparatus, so that the bicycle is tiltable in a direction transversely to the plane defined by a frame of the bicycle, between opposite positions, said apparatus comprising:
a base member,
fastening means to be releasably fastened to the frame of the bicycle and
a mechanism interconnecting the base member and the fastening means, said mechanism being adapted to elevate the fastening means and the bicycle frame connected thereto when the bicycle frame is tilted from an intermediate position towards any of said opposite positions whereby the bicycle frame is biased towards the intermediate position by gravity.

2. An apparatus according to claim 1, wherein the mechanism comprises a connecting member and a linkage connected to the base member, a first end of the connecting member being pivotally and/or spherically connected to the linkage and a second end being connected to the fastening means, the connecting member being mounted so as to follow the tilting movement of the bicycle.

3. An apparatus according to claim 2, wherein the linkage is adapted so as to move the connecting member upwards and/or in a direction opposite the direction of the gravital force acting on the bicycle when the bicycle is tilted towards the opposite positions.

4. An apparatus according to claim 2, further comprising a guide member fixedly connected to the base member and defining retaining means adapted for tiltably and slidingly retaining of the connecting member.

5. An apparatus according to claim 4, wherein the retaining means forms an opening for receiving a pin.

6. An apparatus according to claim 4, wherein the retaining means forms a groove for receiving a ball joint.

7. An apparatus according to claim 2, wherein the linkage comprises at least one primary linkage member and at least one secondary linkage member,
the connecting member being pivotally and/or spherically connected to the at least one primary linkage member,
the at least one secondary linkage member being pivotally and/or spherically connected to the primary linkage member at a first end and at a second end being connected to the base member.

8. An apparatus according to claim 7, wherein the apparatus comprises one primary linkage member and a first and a second secondary linkage member,
the connecting member being pivotally and/or spherically connected to a point on the primary linkage member, said point being positioned between a first end and a second end of the primary linkage member,
a first end of the first secondary linkage member being pivotally and/or spherically connected to the first end of the primary linkage member and a second end of the first secondary linkage member being pivotally and/or spherically connected to the base member
a first end of the second secondary linkage member being pivotally and/or spherically connected to the second end of the primary linkage member and a second end of the second secondary linkage member being pivotally and/or spherically connected to the base member.

9. An apparatus according to claim 1, wherein the opposite positions comprise a first and a second position, said first and second positions being placed on each side of the plane defined by the bicycle frame, the bicycle when tilted to the first and/or when tilted to the second position is tilted with an angle in relation to the gravital force of 45 degrees, such as 40 degrees, such as 35 degrees, such as 30 degrees, such as 25 degrees, such as 20 degrees, such as 15 degrees, such as 12.5 degrees, such as 10 degrees, such as 9 degrees, such as 8 degrees, such as 7 degrees, such as 6 degrees, such as 5 degrees, such as 4 degrees, such as 3 degrees, such as 2 degrees, such as 1 degree.

10. An apparatus according to claim 1, wherein the base member comprises supporting members arranged over a square of a size of 5 square meters, such as 4 square meters, such as 3 square meters, such as 2.5 square meters, such as 2 square meters, such as 1.5 square meters, such as 1 square meters, such as 0.5 square meters.

11. An apparatus according to claim 10, wherein the base member comprises adjustable pinions.

12. An apparatus according to claim 1, wherein the apparatus is made of a material from a group consisting of: wood, plastic, glass fibre, a composite material, rubber, a metal such as iron, steel, aluminium, magnesium, titanium, copper, nickel, zinc or a combination hereof.

13. An apparatus according to claim 1, further comprising resistance providing means, the resistance being applied to the user of the apparatus.

14. An apparatus according to claim 1, wherein the resistance providing means is operable by the user of the bicycle.

15. An apparatus according to claim 13, wherein the resistance providing means is adapted to operate with a frame comprising a primary drive means for transferring force from the user to a secondary drive means via a force transferring connector.

16. An apparatus according to claim 15, wherein the force transferring connector is a chain and/or a belt drive and/or cardan shaft and/or a plurality of toothed wheels

17. An apparatus according to claim 13, wherein the resistance providing means comprises a generator having a axle adapted for rotation around a centre axis.

18. An apparatus according to claim 17, wherein the axle is directly connected to the secondary drive means.

19. An apparatus according to claim 15, wherein the secondary drive means comprises at least one disc having at least one peripheral surface with a radial distance to the centre axis of the axle.

20. An apparatus according to claim 15, wherein the force transferring connector is adapted to engage the peripheral surface so as to transfer movement of the force transferring connector to the peripheral surface of the disc for rotating the axle.

21. An apparatus according to claim 15, wherein the resistance providing means is comprised in a housing, realisably connected to the bicycle.

22. An apparatus according to claim 21, wherein the housing further comprises means for determining the use of one or more brakes attached to the bicycle.

23. An apparatus according to claim 17, wherein the generator is an electrical generator.

24. An apparatus according to claim 23, wherein the electrical generator can be used as a motor and/or a means for generating an electrical power.

25. An apparatus according to claim 23, wherein the electrical generator can generate a maximum torque when the revolutions per minutes is substantially zero.

26. An apparatus according to claim 23, wherein the electrical generator can supply an effect being at least 70% of a maximum effect at a rate of rotation being 10% of a maximum rate of rotation, such as an effect being at least 60% of the maximum effect, such as an effect being at least 50% of the maximum effect, such as an effect being at least 40% of the maximum effect, such as an effect being at least 30% of the maximum effect, an effect being at least 20% of the maximum effect.

27. An apparatus according to claim 17, wherein the generator is an electrical generator having a predefined resistance.

28. An apparatus according to claim 17, wherein the generator is an electrical generator having an adjustable resistance.

29. An apparatus according to claim 27, wherein the electrical generator is connected to control means adapted to adjust the resistance of said generator.

30. An apparatus according to claim 29, wherein the control means is an adjustable electrical resistance electrically connected to the generator, said adjustable electrical resistance being adapted to be releasably attached to a handlebar of the bicycle.

31. An apparatus according to claim 30, wherein the control means comprises
a first computer system with an operating system, the computer system comprising input means for collecting data in a first format, processing means for processing the data, output means for presenting data in a second format, and data storage means having stored therein a computer program.

32. An apparatus according to claim 29, wherein the control means is adapted to vary the resistance over time.

33. An apparatus according to claim 29, wherein the control means is adapted to vary the resistance in response to the number of revolutions per minute of the secondary drive means and/or the primary drive means.

34. An apparatus according to claim 29, wherein the control means is adapted to vary the resistance in response to a heart rate of the user and/or a EKG of the user and/or a blood pressure of the user and/or a oxidation of the blood of the user.

35. An apparatus according to claim 32, wherein the control means is adapted to vary the resistance in response to the heart rate of the user and/or the EKG of the user and/or the blood pressure of the user and/or the oxidation of the blood of the user and/or the time and/or the number of revolutions per minute of the secondary drive means and/or the primary drive means.

36. An apparatus according to claim 32, wherein the control means is adapted to vary the resistance in response to a weight of the user.

37. An apparatus according to claim 29, wherein the control means is adapted to vary the resistance in a predefined pattern.

38. An apparatus according to claim 29, wherein the control means is adapted to vary the resistance in a predefined pattern and in relation to the time and/or number of revolutions per minute of the secondary drive means and/or the primary drive means.

39. An apparatus according to claim 29, wherein the control means is adapted to vary the resistance in a user defined pattern.

40. An apparatus according to claim 29, wherein the control means is adapted to vary the resistance in response to a virtual course, said course being predefined or defined by the user.

41. An apparatus according to claim 29, wherein the control means is adapted to vary the resistance in response to a real course, said course being pre-recorded and stored in the data storage means.

42. An apparatus according to claim 29, wherein the control means is adapted to vary the resistance so as to emulate a virtual gear.

43. An apparatus according to claim 29, wherein the control means is adapted to collect and/or display course information while the bicycle is not attached to the apparatus.

44. An apparatus according to claim 43, wherein the course information is speed and/or position of the bicycle and/or resistance to rolling between the bicycle and a floor on which the bicycle is placed and/or the altitude of the bicycle and/or the angle a plane defined by the floor in relation to the gravital force and/or the speed of the wind and/or the direction of the wind and/or the heart rate of the user and/or the blood pressure of the user and/or the oxidation of the blood of the user and/or revolutions per minute of the secondary drive means and/or the primary drive means.

45. An apparatus according to claim 43, wherein the control means is adapted to collect and/or display at least a part of the course information.

46. An apparatus according to claim 29, wherein at least a part of the control means is adapted to be releasable connected to the bicycle.

47. An apparatus according to claim 29, further comprising means for collecting and/or presenting audio and/or video.

48. An apparatus according to claim 47, further comprising a camera.

49. An apparatus according to claim 47, further comprising a screen for playback of images.

50. An apparatus according to claim 47, further comprising a microphone.

51. An apparatus according to claim 47, further comprising a loudspeaker.

52. An apparatus according to claim 47, wherein the processing means is adapted to display images and/or play sounds and the storing means is adapted to store images and/or sounds.

53. An apparatus according to claim 47, wherein the processing means is adapted to display a virtual route on the screen.

54. An apparatus according to claim 47, wherein the processing means is adapted to playback a real course.

55. A bicycle computer for training with or without an attachable training device, the bicycle computer comprising
a computer system comprising input means for collecting data in a first format, processing means for processing the data, output means for presenting data in a second format, and data storage means having stored therein a computer program,
the computer system being adapted to collect and/or display course information while the bicycle is not connected to the training device and
the computer system being adapted to control resistance providing means comprised in the training device

56. A bicycle computer according to claim 55, wherein the computer during a training session is adapted to display course information from the present session and from at least one reference session.

57. A bicycle computer according to claim 56, wherein the at least one reference session is a previous session

58. A bicycle computer according to claim 56, wherein the at least one reference session is calculated by the computer in accordance with predetermined standard data.

59. A bicycle computer according to claim 55, further comprising an apparatus for training on a bicycle connected to the apparatus, so that the bicycle is tiltable in a direction transversely to the plane defined by a frame of the bicycle, between opposite positions, said apparatus comprising:
a base member,
fastening means to be releasably fastened to the frame of the bicycle and
a mechanism interconnecting the base member and the fastening means, said mechanism being adapted to elevate the fastening means and the bicycle frame connected thereto when the bicycle frame is tilted from an intermediate position towards any of said opposite positions whereby the bicycle frame is biased towards the intermediate position by gravity.

60. A wheel for training on a bicycle comprising a primary drive means and a force transferring connector, said wheel comprising
means for realisably connecting the wheel to the bicycle
resistance providing means comprising secondary drive means adapted to engage with the force transferring connector so as to apply resistance to rotation from the resistance providing means to the primary drive means.

61. A wheel according to claim 60, wherein the wheel is a replacement for a bicycle wheel.

62. A wheel according to claim 60, further comprising the features of an apparatus for training on a bicycle connected to the apparatus, so that the bicycle is tiltable in a direction transversely to the plane defined by a frame of the bicycle, between opposite positions, said apparatus comprising:
a base member,
fastening means to be releasably fastened to the frame of the bicycle and
a mechanism interconnecting the base member and the fastening means, said mechanism being adapted to elevate the fastening means and the bicycle frame connected thereto when the bicycle frame is tilted from an intermediate position towards any of said opposite positions whereby the bicycle frame is biased towards the intermediate position by gravity.
